(19) United States
(12) Patent Application Publication
(10) Pub. No.: US 2026/0214079 A1
(43) Pub. Date: Jul. 23, 2026

(54) Method for securing data transmission, and corresponding system

(71) Applicant: BANKS AND ACQUIRERS INTERNATIONAL HOLDING, SURESNES (FR)

(72) Inventors: Jérome GRANDEMENGE, PARIS (FR); Stéphane BARIZIEN, SURESNES (FR)

(21) Appl. No.: 19/140,459

(22) PCT Filed: Dec. 22, 2023
(86) PCT No.: PCT/EP2023/087657

§ 371 Date: Jun. 18, 2025

(30) Foreign Application Priority Data
Dec. 22, 2022 (FR) FR2214215

(51) Int. Cl. H04L 9/40

(52) U.S. Cl. CPC H04L 63/0428

(57) ABSTRACT

A method for the secure transmission of data between a mobile terminal and an acceptance server. The mobile terminal is configured to communicate with a remote transciphering server via a communication channel and to communicate with the acceptance server. The method is implemented by the mobile terminal and includes: receiving a first key generated by the transciphering server, the first key being variable; encrypting the data using the first key; transmitting the encrypted data to the transciphering server using the first key; receiving the encrypted data by a transactional black box of the transciphering server using a second key; and transmitting the encrypted data to the acceptance server using the second key, the second key being shared between the transciphering server and the acceptance server and not being transmitted to the mobile terminal.

### CROSS-REFERENCE TO RELATED APPLICATIONS

This Application is a Section 371 National Stage Application of International Application No. PCT/EP2023/087657, filed Dec. 22, 2023, and published as WO 2024/133906 A1 on Jun. 27, 2024, not in English, which claims priority to and the benefit of French Patent Application No. FR2214215, filed Dec. 22, 2022, the contents of which are incorporated herein by reference in their entireties.

### FIELD OF THE DISCLOSURE

The present invention concerns the field of secure data transmission, for example for remote payment applications, and in particular to software applications configured to transform a commercial mobile terminal intended for the general public, or non-professional users, into a payment terminal.

### BACKGROUND OF THE DISCLOSURE

It is known to use a software application to transform a commercial mobile terminal intended for non-professional customers, for example a smart phone, in particular a smartphone, or a tablet type, into a payment terminal. Said software application implements a method configured to ensure the entry on the mobile terminal of data relating to the transaction, i.e. data relating to the payment card holder (CHD) and the personal identification code (PIN) which allows to authenticate the payment card holder. It is then necessary to transmit these transaction-related data (CHD, PIN) from the mobile terminal to the acceptance server (SA). To protect the transaction data (CHD, PIN) during their transmission to the acceptance server, it is known to encrypt them.

A simple encryption requires the use of the acceptance server's encryption key. However, storing the acceptance server's encryption key on the mobile terminal should be avoided because the mobile terminal does not meet sufficiently secure security standards.

### SUMMARY

The invention therefore aims to provide a solution to all or some of these problems.

To this end, the present invention concerns a method for the secure transmission of data between a mobile terminal and an acceptance server, the mobile terminal being configured to communicate via a communication channel with a remote transciphering server, and to communicate with the acceptance server, the method comprising the following steps implemented by the mobile terminal:
reception, via the communication channel, of a first key generated by the transciphering server, the first key being variable;
encryption of the data with the first key;
transmission, via the communication channel, to the transciphering server, of the data encrypted with the first key;
reception, via the communication channel, of the data encrypted with a second key by a transactional black box (BNT) of the transciphering server;
transmission of the data encrypted with the second key to the acceptance server, the second key being shared between the transciphering server and the acceptance server and not being transmitted to the mobile terminal.

According to one embodiment, the invention comprises one or more of the following features, alone or in a technically acceptable combination.

According to one embodiment, the communication channel is secure.

According to one embodiment, the first variable key is single-use, i.e., is different for each implementation of the method.

According to one embodiment, the first key is manipulated by the mobile terminal in a volatile memory of the mobile terminal.

According to one aspect, the invention also concerns a method for the secure transmission of data between a mobile terminal and an acceptance server, the mobile terminal being configured to communicate, via a communication channel, with a remote transciphering server comprising a transactional black box, the method comprising the following steps implemented by the transciphering server:
generating a first key, the first key being variable;
transmitting the first key to the mobile terminal via the communication channel;
receiving, via the communication channel, from the mobile terminal, data encrypted by the mobile terminal with the first key;
decrypting, by the transactional black box, with the first key, of the data encrypted with the first key;
encrypting the data, by the transactional black box, with a second key;
transmitting, via the communication channel, to the mobile terminal, of the data encrypted with the second key, the second key being shared between the transciphering server and the acceptance server, and not being transmitted to the mobile terminal.

According to one embodiment, the invention comprises one or more of the following features, alone or in a technically acceptable combination.

According to one embodiment, the communication channel is secure.

According to one embodiment, the first variable key is single-use, i.e., is different for each implementation of the method.

According to one implementation method, the data is an identification code, or CHD code, of the account associated with a payment card and/or an authentication code of an account holder, for example, the elements of a PIN code.

According to another aspect, the present invention also concerns a mobile terminal for secure data transmission with an acceptance server, the mobile terminal comprising an encryption module configured to encrypt the data with a first variable key transmitted by a remote transciphering server, the mobile terminal further comprising a transmission module configured to receive, via a communication channel, the first variable key transmitted by the transciphering server and to transmit, via the communication channel, to the transciphering server, the data encrypted with the first key, the transmission module being further configured to receive from the transciphering server, via the communication channel, the data encrypted with a second key by a transactional black box, then to transmit to the acceptance server the data encrypted with the second key, the second key being shared between the transciphering server and the acceptance server and not being transmitted to the mobile terminal.

According to one embodiment, the mobile terminal further comprises a volatile memory, the first key being manipulated in the volatile memory of the mobile terminal.

According to yet another aspect, the present invention concerns a remote transciphering server for secure data transmission between a mobile terminal and an acceptance server, the transciphering server comprising a generation module configured to generate a first variable key, and a transmission module of the transciphering server configured to transmit the first variable key, via a communication channel, to the mobile terminal, the transmission module of the transciphering server being further configured to receive from the mobile terminal, via the communication channel, the data encrypted with the first key, the transciphering server further comprising a transactional black box configured to receive and decrypt the data encrypted with the first variable key, then encrypt the data with a second key, then to transmit, via the communication channel, to the mobile terminal, the data encrypted with the second key, the second key being shared between the transciphering server and the acceptance server, and not being transmitted to the mobile terminal.

According to one embodiment, the generation module and the transmission module are hosted by a sub-server of the transciphering server, said sub-server being distinct and separate from the transactional black box.

According to yet another aspect, the present invention concerns a system for secure data transmission between a mobile terminal and an acceptance server, the system comprising the mobile terminal according to the embodiment described above, and the transciphering server according to the embodiment described above, the acceptance server being configured to receive from the mobile terminal the data encrypted with a key shared between the transciphering server and the acceptance server, said shared key not being transmitted to the mobile terminal.

### BRIEF DESCRIPTION OF THE DRAWINGS

For a better understanding, an embodiment and/or implementation mode of the invention is described with reference to the attached drawings representing, by way of non-limiting example, an embodiment or implementation mode of a device and/or a method according to the invention. The same references in the drawings designate similar elements or elements whose functions are similar.

FIG. 1 is a schematic representation of the sequencing of the steps of the method according to an embodiment of the invention.

FIG. 2 is a schematic representation of the components of a system according to an embodiment of the invention configured to implement the invention.

### DETAILED DESCRIPTION OF ILLUSTRATIVE EMBODIMENTS

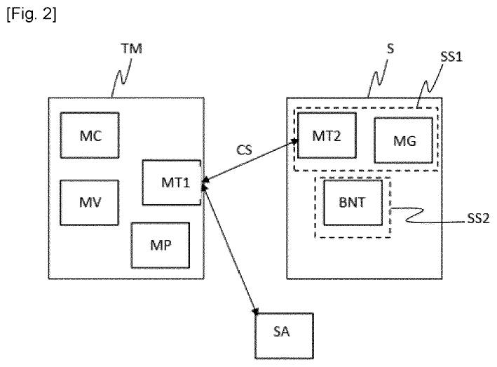

An embodiment example of the invention is schematically illustrated in FIG. 2. It comprises a mobile terminal TM and a transciphering server S, the mobile terminal TM and the transciphering server S being configured together for secure data transmission between the mobile terminal TM and an acceptance server SA. It should be noted that in the described example, the transciphering server S is a remote server in the cloud.

The mobile terminal TM is, for example, a device intended for the general public, non-specialized, comprising, as standard, a hardware module for data transmission. The mobile terminal is preferably a smart phone; it can also be a tablet, or a laptop, for example, which may also comprise a persistent memory module MP and a volatile memory module MV, as schematically illustrated in FIG. 2.

An encryption software module MC is downloaded onto the mobile terminal TM; said encryption software module MC is configured to encrypt the data with a first variable key transmitted by the transciphering server S; a software application is also downloaded to the mobile terminal TM which, together with the standard data transmission hardware module of the mobile terminal TM, forms a data transmission hardware and software module MT1; the data transmission hardware and software module MT1 thus makes it possible to receive, via a communication channel CS, the first variable key transmitted by the transciphering server S and to transmit to the transciphering server S the data encrypted with the first key; the transmission module MT1 is further configured to receive from the transciphering server S, via the communication channel CS, the data encrypted with a second key, by a transactional black box BNT of the transciphering server S, then to transmit to the acceptance server SA the data encrypted with the second key; the second key is shared between the transciphering server S and the acceptance server SA and is not stored on the mobile terminal TM. Moreover, since the transciphering server S is remote and not local, this limits the risk of compromise, particularly physical, of the server aimed at extracting the first and/or second key from the transciphering server.

The communication channel CS is a data communication channel between the mobile terminal TM and the transciphering server S; the communication channel CS is, for example, secured to implement a first level of protection for the data exchanged via this channel. The communication channel is secure when it allows data communication between two mutually authenticated points, the communication being protected confidentially. This first level of data protection can be ensured, for example, by a first encryption of the data exchanged via this secure channel, the method according to the invention ensuring an additional level of protection for the data transmitted by the mobile terminal to the application server. Thus, the secure communication channel allows to guarantee the authenticity and origin of the first key, then of the data encrypted with the first key, and thus to be protected against a «man-in-the-middle» (MITM) attack type.

The first variable key is preferably a single-use key; in other words, each time the method is implemented, a first key is used different than the one used for a previous implementation. The level of protection is thus enhanced.

In particular, the first key is erased immediately after the encryption step by the encryption module of the mobile terminal, and preferably before the transmission step following the encryption step.

More specifically, the first key is manipulated in a volatile memory MV of the mobile terminal TM; in any case, the first key is never stored in a persistent memory module MP of the mobile terminal TM. Thus, the level of protection is further enhanced.

The transciphering server S comprises a generation module MG configured to generate a first variable key, and a transmission module MT2 of the transciphering server configured to transmit the first variable key, via the secure channel CS, to the mobile terminal TM, the transmission module MT2 of the transciphering server is further configured to receive, from the mobile terminal TM, via the secure channel CS, the data encrypted with the first key. Since the transciphering server S is remote, a long-distance network communication is intended to be established between the transciphering server and the mobile terminal TM. Thus, it should be noted that the size of the transmitted data, and in particular the first key, has a significant impact on the data processing time, particularly on the communication speed.

The transciphering server further comprises a transactional black box (BNT) configured to receive and decrypt the encrypted data with the first variable key, then to encrypt the decrypted data with the second key, and then to transmit the encrypted data with the second key to the mobile terminal (TM) via the secure channel (CS), the second key being shared between the transciphering server S and the acceptance server SA.

A transactional black box BNT, sometimes referred to as an HSM or SSM, or SHSM, a term used to describe «Hardware Security Module», «Software Security Module», or «Software and Hardware Security Module», respectively, is a hardware or software component providing a security service that consists of generating, storing, and protecting cryptographic keys.

The HSMSs, for example, meet international security standards such as FIPS 140 and Common Criteria EAL4+.

The generation MG and transmission MT modules can be hosted by a sub server SS1 of the server S; the transactional black box BNT can also be hosted by another sub server SS2 of the server S, distinct from the sub server SS1, the sub server SS2 is thus separate from the sub server SS1, allowing for non-volatile storage of the second key in the transactional black box BNT.

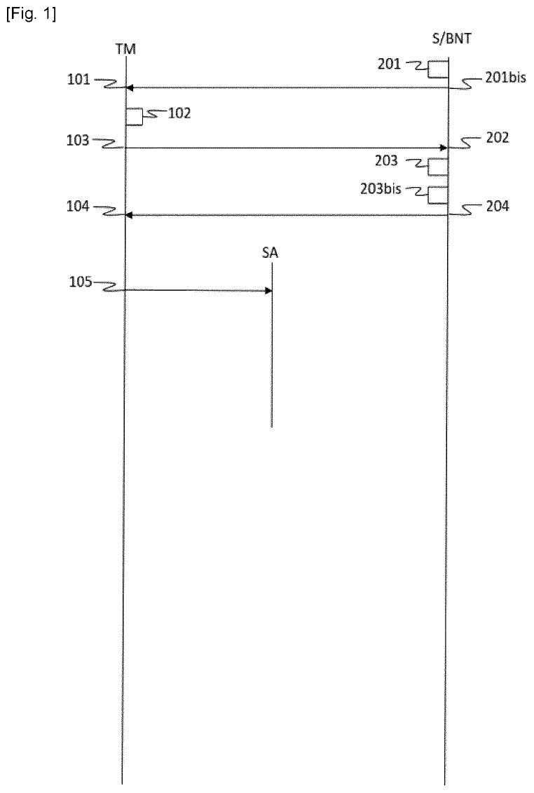

According to one aspect, shown schematically in FIG. 1, the invention concerns a method 100 for the secure transmission of data between a mobile terminal TM and an acceptance server SA, the mobile terminal TM being configured to communicate via a communication channel with a remote transciphering server S, and to communicate with the acceptance server SA, the method 100 comprising the following steps implemented by the mobile terminal TM:
reception 101 via the communication channel CS of a first key generated by the transciphering server S, the first key being variable;
encryption 102 of the data with the first key;
transmission 103 to the transciphering server S, via the communication channel CS, of the data encrypted with the first key;
reception 104 via the communication channel CS of the data encrypted with a second key, by a transactional black box BNT of the transciphering server S;
transmission 105 to the acceptance server SA of data encrypted with the second key, the second key being shared between the transciphering server S and the acceptance server SA, and not being transmitted to the mobile terminal TM.

The communication channel CS is, for example, secure.

The first variable key is, in particular, single-use, i.e., is different for each implementation of the method.

More particularly, the first key is erased immediately after the encryption step 102 by the encryption module MC of the mobile terminal TM, and preferably before the transmission step 103 following the encryption step 102.

According to another aspect, also shown schematically in FIG. 1, the invention concerns a method 200 for the secure transmission of data between a mobile terminal TM and an acceptance server SA, the method 200 comprising the following steps implemented by the transciphering server S:
generation 201 of a first key, the first key being variable;
transmission 201bis, via the secure channel CS, to the mobile terminal TM of the first key;
reception 202, via the secure channel CS, from the mobile terminal of the data encrypted by the mobile terminal TM with the first key;
decryption 203 by the transactional black box BNT with the first key of the data encrypted with the first key;
encryption 203bis of data by the transactional black box BNT with a second key;
transmission 204, via the secure channel CS, to the mobile terminal TM of data encrypted with the second key, the second key being shared between the transciphering server S and the acceptance server SA, and not being transmitted to the mobile terminal TM.

For example, the considered data may be an identification code, or CHD code, of an account associated with a payment card and/or an authentication code of an account holder, for example, the elements of a PIN code.

Although the present disclosure has been described with reference to one or more examples, workers skilled in the art will recognize that changes may be made in form and detail without departing from the scope of the disclosure and/or the appended claims.

1. A method for secure transmission of data between a mobile terminal and an acceptance server, the mobile terminal being configured to communicate via a communication channel with a remote transciphering server, and to communicate with the acceptance server, the method being implemented by the mobile terminal and comprising:
receiving, via the communication channel, a first key generated by the transciphering server, the first key being variable;
encrypting the data with the first key;
transmitting, via the communication channel, the data encrypted with the first key to the transciphering server;
receiving, via the communication channel, the data encrypted with a second key by a transactional black box of the transciphering server; and
transmitting to the acceptance server the data encrypted with the second key, the second key being shared between the transciphering server and the acceptance server and not being received by the mobile terminal.

2. The method according to claim 1, wherein the communication channel is secure.

3. The method according to claim 1, wherein the first key is single-use, which is different for each implementation of the method.

4. The method according to claim 1, wherein the first key is manipulated by the mobile terminal in a volatile memory of the mobile terminal.

5. A method for secure transmission of data between a mobile terminal and an acceptance server, the mobile terminal being configured to communicate via a communication channel with a remote transciphering server comprising a transactional black box, the method being implemented by the transciphering server and comprising:
generating a first key, the first key being variable;
transmitting, via the communication channel, to the mobile terminal the first key;
receiving, via the communication channel, from the mobile terminal, the data encrypted by the mobile terminal with the first key;
decrypting, by the transactional black box, with the first key, the data encrypted with the first key;
encrypting the data, by the transactional black box, with a second key;
transmitting, via the communication channel, to the mobile terminal, of the data encrypted with the second key, the second key being shared between the transciphering server and the acceptance server, and not being transmitted to the mobile terminal.

6. The method according to claim 5, wherein the communication channel is secure.

7. The method according to claim 5, wherein the first variable key is single-use, which is different for each implementation of the method.

8. A mobile terminal for a secure transmission of data with an acceptance server, the mobile terminal comprising:
hardware; and
at least one memory storing software, which together with the hardware configures the mobile terminal to secure transmission of the data between the mobile terminal and the acceptance server, the mobile terminal being configured to communicate via a communication channel with a remote transciphering server, and to communicate with the acceptance server, the securing transmission comprising:
receiving, via the communication channel, a first key generated by the transciphering server, the first key being variable;
encrypting the data with the first key;
transmitting, via the communication channel, the data encrypted with the first key to the transciphering server;
receiving, via the communication channel, the data encrypted with a second key by a transactional black box of the transciphering server; and
transmitting to the acceptance server the data encrypted with the second key, the second key being shared between the transciphering server and the acceptance server and not being received by the mobile terminal.

9. The mobile terminal according to claim 8, wherein the at least one memory comprises a volatile memory, the first key being manipulated in the volatile memory of the mobile terminal.

10. A remote transciphering server for the secure transmission of data between a mobile terminal and an acceptance server, the transciphering server comprising:
a generation module configured to generate a first variable key,
a transmission module configured to transmit the first variable key, via a communication channel, to the mobile terminal, the transmission module being further configured to receive from the mobile terminal, via the communication channel, the data encrypted with the first key, and
a transactional black box configured to receive and decrypt the data encrypted with the first variable key, then encrypt the data with a second key, then to transmit, via the communication channel, to the mobile terminal the data encrypted with the second key, the second key being shared between the transciphering server and the acceptance server, and not being transmitted to the mobile terminal.

11. The transciphering server according to claim 10, wherein the generation module and the transmission module are hosted by a sub-server of the transciphering server, said sub-server being distinct and separate from the transactional black box.

12. (canceled)
